(19) United States
(12) Patent Application Publication
(10) Pub. No.: US 2026/0219048 A1
(43) Pub. Date: Jul. 30, 2026

(54) RESCUE DEVICE AND RESCUE METHOD

(71) Applicant: 3M INNOVATIVE PROPERTIES COMPANY, St. Paul, MN (US)

(72) Inventors: Darin K. Thompson, Huntersville, NC (US); Richard j. Sabacinski, Charlotte, NC (US); William B. Howell, Pineville, NC (US); Traian Morar, Matthews, NC (US); David A. Amero, Calgary (CA); Ivan M. Delamer, Calgary (CA); Todd Hunter, Calgary (CA); Michael J. Z. Norton, Calgary (CA)

(21) Appl. No.: 19/147,639

(22) PCT Filed: Jan. 25, 2024
(86) PCT No.: PCT/IB2024/050724

§ 371 Date: Jul. 11, 2025

Related U.S. Application Data
(60) Provisional application No. 63/481,614, filed on Jan. 26, 2023.

(51) Int. Cl. G01C 21/20; A62B 9/00; A62B 18/08; G08B 5/00; G08B 5/22

(52) U.S. Cl. CPC G01C 21/206; A62B 9/006; A62B 18/08; G08B 5/002; G08B 5/223

(57) ABSTRACT

A portable rescue device (PRD) includes, a sensor, a display unit, and a wireless receiver configured to receive a distress signal from a portable distress device (PDD). The PRD further includes a processor communicably coupled to each of the display unit, the wireless receiver, and the sensor. The processor is configured to determine one or more path obstacles disposed in a first direction between the wireless receiver and the PDD along which the distress signal has a maximum signal strength based on an obstacle signal generated by the sensor. The processor is further configured to determine at least one obstacle-free path unobstructed by the one or more path obstacles. The processor is further configured to determine at least one set of guiding directions for guiding the user along the at least one obstacle-free path. The processor is further configured to display the at least one set of guiding directions.

### TECHNICAL FIELD

The present disclosure generally relates to a portable rescue device (PRD) and a rescue method. The present disclosure also relates to an article of personal protective equipment (PPE) including the PRD.

### BACKGROUND

In an event of an emergency, first responders and emergency workers may arrive at a scene without complete knowledge of a layout of the scene. Further, emergency workers may often suffer from disorientation and/or lack of information when entering the scene to rescue a trapped item/person/fellow team member. For example, in case of a fire in a building, emergency workers may arrive in the building without knowledge of an interior layout or interior condition of the building. Building layouts and maps may not be always available or may be difficult to use inside enclosed spaces that are out of visible light. In addition, the interiors of the building may be altered or may possess dangerous conditions, with some locations or corridors being blocked or impassable.

It may therefore be challenging to find an item/person in an unknown location. Further, it may be difficult to carry out a rescue operation when inside an unknown building structure. Currently, rescue technologies are available that may assist search and rescue teams in locating downed, trapped, or lost personnel (e.g., a firefighter or other emergency personnel) through smoke and other immediately dangerous to life or health (IDLH) environments. Such rescue technologies utilize radio waves between a receiver and a transmitter to help locate a trapped person. However, such rescue technologies may only direct in a straight path, sometimes through walls/obstructions. Therefore, in some cases, such straight paths may be difficult or impossible for the rescue teams to follow.

### SUMMARY

In a first aspect, the present disclosure provides a portable rescue device (PRD) carried by a user. The PRD includes a display unit and a wireless receiver configured to receive a distress signal from a portable distress device (PDD) associated with a personnel. The PRD further includes at least one sensor configured to generate at least one obstacle signal indicative of one or more obstacles in an ambient environment around the PRD. The PRD further includes a processor communicably coupled to each of the display, the wireless receiver, and the at least one sensor. The processor is configured to determine a signal strength of the distress signal along one or more directions. The processor is further configured to determine, based on the signal strength of the distress signal, a first direction between the wireless receiver and the PDD along which the distress signal has a maximum signal strength. The first direction corresponds to a minimum distance between the wireless receiver and the PDD. The processor is further configured to determine one or more path obstacles disposed in the first direction between the wireless receiver and the PDD based on the at least one obstacle signal received from the at least one sensor. The processor is further configured to determine at least one obstacle-free path between the wireless receiver and the PDD based on the one or more path obstacles and the first direction. The at least one obstacle-free path is unobstructed by the one or more path obstacles. The processor is further configured to determine at least one set of guiding directions for guiding the user to the PDD along the at least one obstacle-free path. The at least one set of guiding directions includes at least one guiding direction. The processor is further configured to display, via the display unit, the at least one set of guiding directions.

In a second aspect, the present disclosure provides an article of personal protective equipment (PPE) including the PRD of the first aspect.

In a third aspect, the present disclosure provides a rescue method. The rescue method includes receiving, via a wireless receiver, a distress signal from a portable distress device (PDD) associated with a personnel. The rescue method further includes determining, via a processor communicably coupled to the wireless receiver, a signal strength of the distress signal along one or more directions. The rescue method further includes determining, via the processor, a first direction between the wireless receiver and the PDD along which the distress signal has a maximum signal strength based on the signal strength of the distress signal. The first direction corresponds to a minimum distance between the wireless receiver and the PDD. The rescue method further includes generating, via at least one sensor communicably coupled to the processor, at least one obstacle signal indicative of one or more obstacles in an ambient environment. The rescue method further includes determining, via the processor, one or more path obstacles disposed in the first direction between the wireless receiver and the PDD. The rescue method further includes determining, via the processor, at least one obstacle-free path between the wireless receiver and the PDD based on the one or more path obstacles and the first direction. The at least one obstacle-free path is unobstructed by the one or more path obstacles. The rescue method further includes determining, via the processor, at least one set of guiding directions for guiding a user to the PDD along the at least one obstacle-free path. The at least one set of guiding directions includes at least one guiding direction. The rescue method further includes displaying, via a display unit communicably coupled to the processor, the at least one set of guiding directions.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a schematic view of a hallway and a portable rescue device (PRD) carried by a user, according to an embodiment of the present disclosure;

FIG. 2 is a block diagram illustrating the PRD, according to an embodiment of the present disclosure;

FIG. 3 is a block diagram illustrating the PRD, according to another embodiment of the present disclosure;

FIG. 4 is a block diagram illustrating the PRD, according to another embodiment of the present disclosure;

FIG. 5 is a block diagram illustrating the PRD, according to another embodiment of the present disclosure;

FIG. 6 is a schematic perspective view of an article of personal protective equipment (PPE), according to an embodiment of the present disclosure;

FIG. 7 is schematic view of a display unit, according to an embodiment of the present disclosure; and

FIG. 8 is a flowchart illustrating a rescue method, according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the following disclosure, the following definitions are adopted.

As used herein, the term “transmitter” may generally include any device, circuit, or apparatus capable of transmitting an electrical signal.

As used herein, the term “receiver” may generally comprise any device, circuit, or apparatus capable of receiving an electrical signal.

As used herein, the term “Wi-Fi” refers generally to a bi-directional radio communication technology that operates based on one or more of the ‘Institute of Electrical and Electronics Engineers’ (“IEEE”) 802.11 family of standards, which are incorporated herein by reference. The IEEE 802.11 standards specify the radio frequency (RF) and protocol characteristics of a bi-directional radio communication system.

As used herein, the term “coupled” generally means either a direct connection between two or more elements that are connected or an indirect connection through one or more passive or active intermediary devices.

As used herein, the term “communicably coupled” generally refers to any type of connection or coupling that allows for communication of information. The term communicably coupled may include, but is not limited to, electrically coupled (e.g., through a wire), optically coupled (e.g., through an optical cable), audibly coupled, wirelessly coupled (e.g., through a radio frequency or other similar technologies), and/or the like. The technology by which the information is transmitted is not material to the meaning of communicably coupled.

As used herein, the term “signal,” includes, but is not limited to, one or more electrical signals, optical signals, electromagnetic signals, analog and/or digital signals, one or more computer instructions, a bit and/or bit stream, and/or the like.

As used herein, the term “signal strength,” generally refers to a measured field strength or radiation power, depending on the application.

As used herein, the term “hazardous or potentially hazardous conditions” may be used throughout the disclosure to include environmental conditions, such as high ambient temperature, lack of oxygen, and/or the presence of explosive, exposure to radioactive or biologically harmful materials, and exposure to other hazardous substances. Examples of hazardous or potentially hazardous conditions may include, but are not limited to, fire fighting, biological and chemical contamination clean-ups, explosive material handling, working with radioactive materials, and working in confined spaces with limited or no ventilation. The term “hazardous or potentially hazardous conditions” may also be used throughout the disclosure to refer to physiological conditions associated with an individual, such as heart rate, respiration rate, core body temperature, or any other condition which may result in injury and/or death of an individual.

As used herein, all numbers should be considered modified by the term “about”. As used herein, “a,” “an,” “the,” “at least one,” and “one or more” are used interchangeably.

The term “about”, unless otherwise specifically defined, means to a high degree of approximation (e.g., within +/−5% for quantifiable properties) but again without requiring absolute precision or a perfect match.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

As used herein, the term “configured to” and like is at least as restrictive as the term “adapted to” and requires actual design intention to perform the specified function rather than mere physical capability of performing such a function.

Conventionally, rescue devices employ radio frequency technologies to help locate a trapped person, e.g., in an emergency situation such as fires. Particularly, such rescue devices may assist search and rescue teams in locating downed, trapped, or lost firefighters or other emergency personnel through smoke and other immediately dangerous to life or health (IDLH) environments. Generally, such rescue devices are a two-part system including a transmitter and a receiver. A rescuer utilizes the receiver to detect a radio frequency signal from the transmitter associated with personnel to be located. However, radio frequency signals may only direct in a straight path, sometimes through walls/obstructions. Therefore, in some cases, such straight paths may be difficult or impossible for the rescue teams to follow.

The present disclosure provides a portable rescue device (PRD) carried by a user. The PRD includes a display unit and a wireless receiver configured to receive a distress signal from a portable distress device (PDD) associated with a personnel. The PRD further includes at least one sensor configured to generate at least one obstacle signal indicative of one or more obstacles in an ambient environment around the PRD. The PRD further includes a processor communicably coupled to each of the display, the wireless receiver, and the at least one sensor. The processor is configured to determine a signal strength of the distress signal along one or more directions. The processor is further configured to determine, based on the signal strength of the distress signal, a first direction between the wireless receiver and the PDD along which the distress signal has a maximum signal strength. The first direction corresponds to a minimum distance between the wireless receiver and the PDD. The processor is further configured to determine one or more path obstacles disposed in the first direction between the wireless receiver and the PDD based on the at least one obstacle signal received from the at least one sensor. The processor is further configured to determine at least one obstacle-free path between the wireless receiver and the PDD based on the one or more path obstacles and the first direction. The at least one obstacle-free path is unobstructed by the one or more path obstacles. The processor is further configured to determine at least one set of guiding directions for guiding the user to the PDD along the at least one obstacle-free path. The at least one set of guiding directions includes at least one guiding direction. The processor is further configured to display, via the display unit, the at least one set of guiding directions.

The PRD of the present disclosure may receive the distress signal from the PDD associated with the personnel (e.g., a trapped emergency worker) to help locate the personnel inside an enclosed structure, such as a building. Further, the processor may determine the first direction between the wireless receiver and the PDD along which the distress signal has the maximum signal strength, e.g., a straight path to the PDD. Subsequently, the processor may determine presence of the one or more path obstacles disposed in the first direction between the wireless receiver and the PDD (i.e., along the straight path to the PDD) based on the at least one obstacle signal received from the at least one sensor. Thus, the PRD of the present disclosure may be able to detect the one or more path obstacles along the first direction. Further, the processor may determine the at least one obstacle-free path based on the one or more path obstacles and the first direction, thereby circumventing the one or more path obstacles and avoiding a path that may be blocked or impassable.

Thus, the PRD of the present disclosure may assist in tracking (or locating) the personnel by considering the one or more path obstacles and determining the best path to reach the personnel. Further, the PRD may save time in rescuing the personnel by avoiding disorientation. The PRD may also provide the at least one set of guiding directions via the display unit, thereby guiding the user along the at least one obstacle-free path. In some examples, at least one obstacle-free path may include multiple obstacle-free paths. The PRD may allow the user to choose a suitable obstacle-free path based on, e.g., a length of the obstacle-free path, ease of reaching the personnel, time required to reach the personnel, etc. Further, the at least one set of guiding directions may include the at least one guiding direction that may be dynamically updated along the obstacle-free path to the PDD.

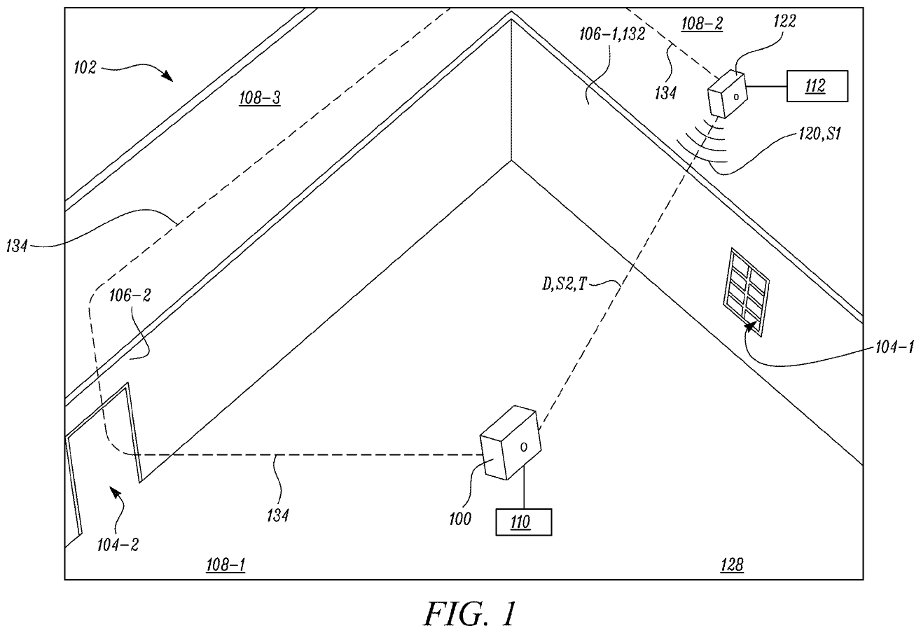

FIG. 1 is a schematic view of a hallway 102. In some examples, the hallway 102 may be a portion of a building, a house, or any other similar enclosed construction. Only a portion of the hallway 102 is shown in FIG. 1 for illustrative purposes. In some examples, the hallway 102 may have limited visibility. For example, the hallway 102 may be out of visible light or may be covered with smoke due to fire. FIG. 1 also shows a portable rescue device (PRD) 100 carried by a user 110. In some examples, the user 110 may be an emergency personnel, e.g., a firefighter, a law enforcement personnel, a medical personnel, a first responder, a paramedic, or other personnel working in potentially hazardous environments, e.g., fires.

In some examples, the hallway 102 includes a plurality of zones 108-1, 108-2, 108-3 (collectively, zones 108) separated by one or more obstacles 106-1, 106-2 (collectively, obstacles 106). In the illustrated embodiment of FIG. 1, the one or more obstacles 106 includes walls, partition panels, glass panes, windows, dry walls, etc. Further, the zone 108-1 and the zone 108-2 are connected through the zone 108-3. In some examples, the hallway 102 further includes one or more openings 104-1, 104-2 (collectively, openings 104). The one or more openings 104 may be a doorway, a window, or an emergency exit. It should be understood that the hallway 102 described with reference to FIG. 1 is shown by way of example only.

The PRD 100 carried by the user 110 may assist in rescuing a personnel 112 trapped in the hallway 102. In some examples, the personnel 112 may be another emergency personnel downed, trapped, or lost in the hallway 102. In the illustrated embodiment of FIG. 1, the personnel 112 is shown in the zone 108-2. In some examples, the personnel 112 may be injured or unconscious.

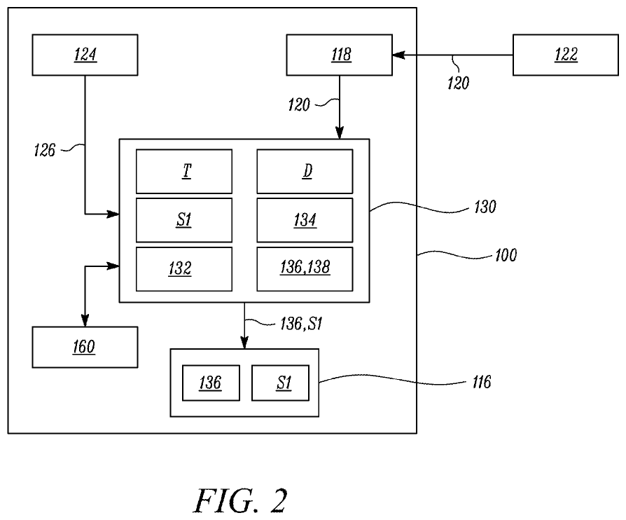

FIG. 2 is a block diagram illustrating the PRD 100. Referring now to FIGS. 1 and 2, the PRD 100 includes a wireless receiver 118 configured to receive a distress signal 120 from a portable distress device (PDD) 122 associated with the personnel 112. In some examples, the PDD 122 may include a wireless transmitter. The PDD 122 may be a part of a personal alert safety system (PASS) device. Generally, the PASS device may be a battery-powered device designed to assist the emergency personnel during their mission.

In some examples, the PASS device may be carried by the personnel 112 and may generate the distress signal 120 and/or sound a loud audible alert to notify others if the personnel 112 is in distress. For example, the PASS device may be attached to a backpack style harness for a self-contained breathing apparatus (SCBA), a turnout coat, or any other protective clothing worn by the personnel 112. Further, the PASS device may be activated manually or automatically. For example, the PASS device may be triggered manually by pressing a button, or automatically by a motion sensing device that triggers the PASS device when the personnel 112 has not moved in a certain threshold amount of time, e.g., when the personnel 112 is unconscious.

In some examples, when the PASS device detects the immobility of the personnel 112, the PDD 122 may automatically generate the distress signal 120 in all directions to notify that the personnel 112 is in a hazardous situation and may need to be rescued. In some examples, the PASS device may typically not turn itself off unless manually reset. Thus, the PDD 122 may keep on generating the distress signal 120 in all directions that may be received by the wireless receiver 118 of the PRD 100, such that the user 110 may follow the distress signal 120 to locate the personnel 112 and subsequently rescue the personnel 112.

In some examples, the PDD 122 may utilize radio waves for transmitting the distress signal 120. For example, the PDD 122 may utilize 2.4 GHz radio frequency (RF) protocols such as Zigbee, long range (LoRa), etc., ultra-wideband (UWB), Bluetooth®, angle of arrival (AoA), angle of departure (AoD), WiFi, Z-Wave, etc., to transmit the distress signal 120. Examples are intended to include or otherwise cover any type of wireless communication protocol, including known or related art, and/or later developed technologies for transmitting the distress signal 120.

The PRD 100 further includes at least one sensor 124 configured to generate at least one obstacle signal 126 indicative of the one or more obstacles 106 in an ambient environment 128 (shown in FIG. 1) around the PRD 100. In some examples, the at least one sensor 124 may be disposed on the PRD 100 or may be directly or indirectly coupled to the PRD 100. The at least one sensor 124 may be any type of sensor that may be able to detect the one or more obstacles 106 in the ambient environment 128, e.g., an image sensor, such as a camera (picture and/or video), a radar, a sound sensor, etc.

In some examples, the at least one sensor 124 may also include other types of sensors, such as, for example, proximity/position sensors, force sensors, distance sensors, and/or the like. In some examples, the proximity/position sensor may include a gyroscope, a compass, a geomagnetic sensor, and/or the like. In some examples, the at least one sensor 124 may have specific sensing factors. For instance, the sensing factor may include accuracy, e.g., a statistical variance about an exact reading; calibration constraints; cost; environmental factors, such as temperature and/or humidity limits; range factors, e.g., limits of measurement; repeatability, such as a variance in an output of the at least one sensor 124 when a single condition is repeatedly measured; and resolution, e.g., a smallest increment the sensor may detect with accuracy.

The PRD 100 further includes a display unit 116. In some examples, the display unit 116 may be disposed on the PRD 100. In some other examples, the display unit 116 may include a liquid crystal display (LCD), an organic light emitting diode (OLED), a flat panel display, a solid state display, a plasma display, or any other display technology, for displaying information or content to the user 110. The PRD 100 further includes a processor 130 communicably coupled to each of the display unit 116, the wireless receiver 118 and the at least one sensor 124. In some examples, the PRD 100 further includes a memory 160 communicably coupled to the processor 130.

In some examples, the processor 130 may be embodied in a number of different ways. For example, the processor 130 may be embodied as various processing means, such as one or more of a microprocessor or other processing elements, a coprocessor, or various other computing or processing devices, including integrated circuits, such as, for example, an ASIC (application specific integrated circuit), an FPGA (field programmable gate array), or the like. In some examples, the processor 130 may be configured to execute instructions stored in a memory 160. In some examples, the memory 160 may be a cache memory, a system memory, or other memory. Alternatively, or in addition, the memory 160 may be integral with the processor 130, such as a cache or random-access memory for the processor 130.

As such, whether configured by hardware, or by a combination of hardware and software, the processor 130 may represent an entity (e.g., physically embodied in a circuitry—in the form of a processing circuitry) capable of performing operations according to some embodiments while configured accordingly. Thus, for example, when the processor 130 is embodied as an ASIC, FPGA, or the like, the processor 130 may have specifically configured hardware for conducting the operations described herein. Alternatively, as another example, when the processor 130 may be embodied as an executor of software instructions, the instructions may specifically configure the processor 130 to perform the operations described herein.

In some examples, the memory 160 may be configured to store data. In some examples, the processor 130 may create, read, update, and delete data stored within the memory 160. The functions, acts, or tasks illustrated in the figures or described herein may be performed by the processor 130 executing instructions stored in the memory 160. The functions, acts, or tasks may be independent of a particular type of instruction set, a storage media, a processor or processing strategy, and may be performed by a software, a hardware, an integrated circuit, a firmware, a micro-code, and/or the like, operating alone or in combination.

In some examples, the memory 160 may be a main memory, a static memory, or a dynamic memory. The memory 160 may include, but may not limited to, computer readable storage media, such as various types of volatile and non-volatile storage media, including, but not limited to, random access memory (RAM), read-only memory (ROM), programmable read-only memory, electrically programmable read-only memory (EPROM), electrically erasable programmable read-only memory (EEPROM), flash memory, magnetic tape or disk, optical media, solid-state memory array, and/or the like.

The processor 130 is configured to determine a signal strength S1 of the distress signal 120 along one or more directions. For example, the user 110 may look for the distress signal 120 in the one or more directions by pointing the PRD 100 or the wireless receiver 118 in the one or more directions for determining the signal strength S1. In some examples, when the distress signal 120 is received by the PRD 100 in the one or more directions through the wireless receiver 118, the detected signal 120 is passed on to a receiving circuitry that converts the detected signal 120 into corresponding electrical signals for processing by the processor 130. In some examples, the processor 130 may determine the signal strength S1 by calculating one or more signal strength metrics, such as received signal code power (RSCP), reference signal received power (RSRP), reference signal received quality (RSRQ), received signal strength indicator (RSSI), signal to noise ratio (SNR), and signal to interference plus noise ratio (SINR). In some examples, the processor 130 is further configured to display, via the display unit 116, the signal strength S1 of the distress signal 120.

The processor 130 is further configured to determine, based on the signal strength S1 of the distress signal 120, a first direction D (shown in FIG. 1) between the wireless receiver 118 and the PDD 122 along which the distress signal 120 has a maximum signal strength S2. In other words, the first direction D may correspond to a direction in which the signal strength S1 of the distress signal 120 is maximum that is determined based on scanning the distress signal 120 in the one or more directions through the PRD 100. The first direction D corresponds to a minimum distance T between the wireless receiver 118 and the PDD 122. In some examples, the one or more obstacles 106 (e.g., walls) may obstruct a propagation path of the distress signal 120 and may cause partial loss of the signal strength S1.

The processor 130 is further configured to determine one or more path obstacles 132 disposed in the first direction D between the wireless receiver 118 and the PDD 122 based on the at least one obstacle signal 126 received from the at least one sensor 124. As used herein, the term “path obstacles” may refer to the one or more obstacles 106 (e.g., walls) that may obstruct a path of the user 110 along the first direction D. In other words, the one or more path obstacles 132 may obstruct the user 110 if the user 110 wishes to move along the first direction D with minimum distance T to the personnel 112. In the illustrated example of FIG. 1, the obstacle 106-1, also acting as the path obstacle 132, may obstruct the user 110 if the user 110 wishes to reach the personnel 112 by moving along the first direction D with the maximum signal strength S2 corresponding to the minimum distance T between the PDD 122 and the wireless receiver 118.

The processor 130 is further configured to determine at least one obstacle-free path 134 between the wireless receiver 118 and the PDD 122 based on the one or more path obstacles 132 and the first direction D. The at least one obstacle-free path 134 is unobstructed by the one or more path obstacles 132. In some examples, the processor 130 is configured to determine the at least one obstacle-free path 134 based on inputs from the at least one sensor 124.

In the illustrated embodiment of FIG. 1, the at least one obstacle-free path 134 passes from the zone 108-1 to the zone 108-3 through the opening 104-1 and then to the zone 108-2. Thus, the processor 130 may determine the at least one obstacle-free path 134 that circumvents the one or more path obstacles 132 between the wireless receiver 118 and the PDD 122 based on inputs received from the at least one sensor 124. Therefore, the PRD 100 may obtain a path (i.e., the at least one obstacle-free path 134) that would otherwise be blocked or obstructed, e.g., the path along the first direction D. Further, the at least one obstacle-free path 134 may be indicative of the easiest path to the personnel 112 while avoiding the one or more path obstacles 132. The term “at least one obstacle-free path 134” is interchangeably refereed to hereinafter as the “obstacle-free path 134”.

In some examples, the processor 130 may dynamically update the at least one obstacle-free path 134 based on a movement of the user 110. For example, the processor 130 may keep on updating the at least one obstacle-free path 134 based on the one or more path obstacles 132 that come up when moving along the at least one obstacle-free path 134. Thus, the PRD 100 may be self-sufficient in determining an unobstructed path to the personnel 112.

In some examples, the processor 130 is further configured to determine the at least one obstacle-free path 134 without any predetermined map data. In other words, the processor 130 may only need inputs from the at least one sensor 124 for determining the at least one obstacle-free path 134. Thus, the PRD 100 of the present disclosure may be especially useful in cases where floor plans or layouts are not generally available or connection to external servers is not available. Additionally, the PRD 100 may not require inputs from location devices, such as a global positioning system (GPS) device.

The processor 130 is further configured to determine at least one set of guiding directions 136 for guiding the user 110 to the PDD 122 along the at least one obstacle-free path 134. The at least one set of guiding directions 136 includes at least one guiding direction 138. Particularly, the at least one guiding direction 138 includes directional indicators (e.g., pointers, arrows) that guide the user 110 along the at least one obstacle-free path 134 to the personnel 112. All such directional indicators may together form the set of guiding directions 136.

The processor 130 is further configured to display, via the display unit 116, the at least one set of guiding directions 136. Particularly, the processor 130 may display the at least one guiding direction 138 from the at least one set of guiding directions 136 on the display unit 116, such that the user 110 may be able to follow the at least one guiding direction 138 in order to move along the at least one obstacle-free path 134 to the personnel 112 using the PRD 100.

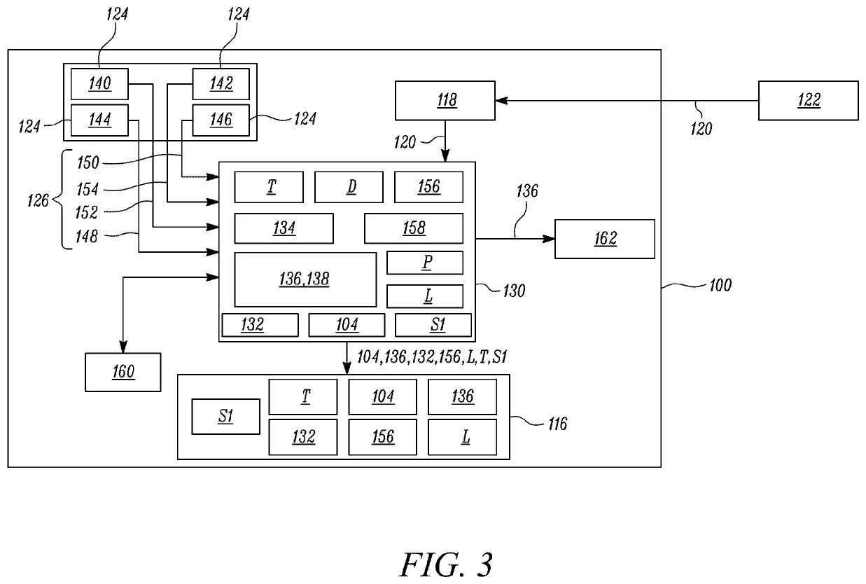

FIG. 3 is a block diagram illustrating the PRD 100, according to another embodiment of the present disclosure. Referring now to FIGS. 1 and 3, the at least one sensor 124 includes a plurality of sensors 124 configured to generate a corresponding plurality of obstacle signals 126 indicative of the one or more obstacles 106 in the ambient environment 128. In some examples, the at least one sensor 124 includes at least one of a lidar unit 140, a sonar unit 142, an infrared sensor 144, and a visible light sensor 146.

As used herein, the term “lidar” is an acronym for Light Detection and Ranging and generally refers to an optical remote sensing technology that uses a light source (e.g., laser light) for detection of an object by illuminating the object with the light source. As used herein, the term “light source” generally refers to any source capable of emitting photons. As used herein, the term “laser” is an acronym for Light Amplification by Stimulated Emission of Radiation and generally refers to coherent light with a narrow range of wavelengths. As used herein, the term “light” must be understood broadly, since lasers have covered radiation at wavelengths ranging from infrared range to ultraviolet and even soft x-ray range. In some examples, the lidar unit 140 may utilize ultraviolet (UV), visible, or infrared light to image objects (e.g., the one or more obstacles 106).

In some examples, the lidar unit 140 may include a laser source or a laser scanner that emits laser pulses and a detector that receives reflections of the laser pulses. In some examples, the lidar unit 140 may include components, such as a light source, scanner and optics, a photodetector and receiver electronics, and position and navigation system. In some examples, a suitable laser beam (e.g., wide or narrow) may be chosen to determine physical features of the one or more obstacles 106 with high resolution. In some examples, the lidar unit 140 may also assist in identifying the personnel 112 by detecting physical features of the personnel 112.

As used here, the term “sonar” is an acronym for Sound Navigation and Ranging and generally refers to any equipment that generates and receives sound waves for detection of objects (e.g., the one or more obstacles 106). In other words, the sonar unit 142 utilizes sound propagation to detect objects. In some examples, the sonar unit 142 may include one or more transducers for sending and receiving sound waves, electronic equipment for generation and detection of electrical impulses to and from the transducers, and signal processing means for analysis of received signals. In some examples, the sonar unit 142 may be able to differentiate between different objects as the sound waves reflect off from different objects in different ways.

The infrared sensor 144 generally refers to all kinds of known and suitable infrared detectors, such as, for example, thermopiles, thermistors, bolometers, pyroelectric sensors, and semiconductor sensors. In some examples, the infrared sensor 144 may include an infrared light emitting unit and a light receiving unit, including a photo resistor (PTR) or a photodiode (PD), to detect an amount of a reflected light. When the light emitted from the light emitting unit is reflected from a surface of the object and is incident upon the light receiving unit, the infrared sensor 144 may generate an image of the object.

The visible light sensor 146 generally refers to any sensor (e.g., a camera) capable of sensing energy in the visible region of the electromagnetic spectrum and correspondingly generating images from the sensed energy. The visible light sensor 146 may then transmit the images through electrical signals.

In some examples, the lidar unit 140, the sonar unit 142, the infrared sensor 144, and the visible light sensor 146 are configured to generate the plurality of obstacle signals 126. Specifically, the plurality of obstacle signals 126 include at least one of an infrared signal 148 and a visible light signal 150. In some examples, the plurality of obstacle signals 126 further include at least one of a lidar signal 152 and a sonar signal 154. Specifically, the lidar unit 140, the sonar unit 142, the infrared sensor 144, and the visible light sensor 146 generate the lidar signal 152, the sonar signal 154, the infrared signal 148, and the visible light signal 150, respectively.

In some examples, the processor 130 is further configured to fuse the plurality of obstacle signals 126 in order to determine the one or more path obstacles 132. For example, the processor 130 is configured to fuse the infrared signal 148 or the visible light signal 150 with the lidar signal 152 or the sonar signal 154 to determine the one or more path obstacles 132. Thus, the processor 130 may be able to accurately determine the one or more path obstacles 132 through inputs from the various sensors.

In some examples, the processor 130 may utilize inputs from the visible light sensor 146 and the lidar unit 140 to determine physical characteristics of the one or more path obstacles 132 as well as a distance between the PRD 100 and the one or more path obstacles 132, thereby generating a three-dimensional environment around the PRD 100. Further, the lidar unit 140, the sonar unit 142, the infrared sensor 144, and the visible light sensor 146 may be intended to detect the one or more path obstacles 132 in different directions, thereby allowing the processor 130 to detect the one or more path obstacles 132 in multiple directions.

In some examples, the processor 130 is further configured to determine the one or more path obstacles 132 further based on object detection 158. For example, the processor 130 may determine the one or more path obstacles 132 by determining physical characteristics of the one or more path obstacles 132 through inputs (e.g., images) received from the plurality of sensors 124 (i.e., the lidar unit 140, the sonar unit 142, the infrared sensor 144, and the visible light sensor 146).

As used herein, the term “object detection” generally refers to detection of an object in a digital image. In some example, the object may be a human, an article of furniture, and so on. In some examples, the object detection 158 may utilize image processing techniques, e.g., a fuzzy logic image processing technique, a computer vision technique, a shape detection technique, a feature extraction technique, a technique that includes use of a color histogram, a motion detection technique, and/or the like for determining the one or more path obstacles 132. In some examples, the processor 130 is further configured to display, via the display unit 116, the one or more path obstacles 132.

In some examples, the processor 130 is further configured to determine a parameter 156 associated with the one or more path obstacles 132 based on the at least one obstacle signal 126. The parameter 156 is indicative of a construction of the one or more path obstacles 132. In some examples, the construction may include a structural strength of the one or more path obstacles 132. In some examples, the processor 130 may determine the parameter 156 based on inputs form the plurality of sensors 124 (i.e., the lidar unit 140, the sonar unit 142, the infrared sensor 144, and the visible light sensor 146).

In some examples, the parameter 156 may include, e.g., a density, an elasticity, a porosity, etc. of the one or more path obstacles 132. In some examples, the processor 130 is further configured to display, via the display unit 116, the parameter 156. Thus, the user 110 may decide to move around the one or more path obstacles 132 or through the one or more path obstacles 132 based on the parameter 156. For example, the user 110 may decide to move through a wall made of plaster board.

The processor 130 is further configured to determine the one or more openings 104 (e.g., the openings 104-1) through the one or more path obstacles 132 based on the at least one obstacle signal 126. In some examples, the processor 130 may determine the one or more openings 104 based on inputs form the plurality of sensors 124 (i.e., the lidar unit 140, the sonar unit 142, the infrared sensor 144, and the visible light sensor 146). The processor 130 is further configured to display, via the display unit 116, the one or more openings 104. Thus, the user 110 may be made aware of the one or more openings 104 through the one or more path obstacles 132.

In some examples, the memory 160 is configured to store the at least one set of guiding directions 136. In some examples, the memory 160 is further configured to store inputs (e.g., images of the one or more obstacles 106) obtained through the plurality of sensors 124. In some examples, the inputs from the plurality of sensors 124 and the at least one set of guiding directions 136 may be later accessed for training and monitoring purposes. For example, a learning model may be trained for determining the at least one set of guiding directions 136 based on the one or more obstacles 106.

In some examples, the processor 130 may be communicably coupled to a remote server or a cloud database that may store data related to emergency personnel. In some examples, the data may include information, such as name, sex, age, height, weight, body features, facial features, and other distinguishing features. In some examples, the processor 130 may be able to identify the personnel 112 based on inputs from the plurality of sensors 124 and the information related to emergency personnel. In some examples, the processor 130 may include one or more image processing algorithms that may assist in identifying the personnel 112. In some examples, the one or more image processing algorithms may be trained using machine learning. In some examples, the processor 130 may transmit the inputs received from the plurality of sensors 124 to the remote server.

In some examples, the processor 130 is further configured to dynamically update the at least one set of guiding directions 136 based on a position P of the user 110 along the at least one obstacle-free path 134. Thus, the processor 130 may keep on updating the at least one set of guiding directions 136 as the processor 130 receives inputs from the plurality of sensors 124 indicative of the one or more path obstacles 132 while moving along the at least one obstacle-free path 134, thereby guiding the user 110 along at least one obstacle-free path 134. In some examples, the processor 130 may consider the current position P of the user 110, divergence along the at least one obstacle-free path 134, time available until the next guidance, etc., while dynamically updating the at least one set of guiding directions 136.

In some examples, the processor 130 is further configured to dynamically update the obstacle-free path 134 as the user 110 moves along the previously determined obstacle-free path 134 based on the distress signal 120 and the one or more path obstacles 132. For example, the processor 130 may determine in real-time whether a new or better route is available to reach the personnel 112. Further, when an alternate obstacle-free path 134 is available, the processor 130 may dynamically update the at least one set of guiding directions 136.

In some examples, the processor 130 is further configured to determine a remaining distance L between the PDD 122 and the wireless receiver 118 along the at least one obstacle-free path 134. In other words, the processor 130 may calculate the remaining distance L between the PDD 122 and the wireless receiver 118 as the user 110 moves along the obstacle-free path 134. Further, the processor 130 may dynamically update the remaining distance L based on the position P of the user 110 along the at least one obstacle-free path 134. In some examples, the processor 130 is further configured to display, via the display unit 116, the remaining distance L. Thus, the user 110 may be made aware of the remaining distance L to the personnel 112.

In some examples, the PRD 100 further includes an audio device 162 communicably coupled to the processor 130. The processor 130 is further configured to output, via the audio device 162, the at least one set of guiding directions 136. In some examples, the audio device 162 may be disposed on the PRD 100. In some examples, the audio device 162 may be a speaker configured to receive audio signals form the processor 130. Thus, the audio device 162 may output the at least one set of guiding directions 136 along the obstacle-free path 134 and the user 110 may not have to always look at the display unit 116, thereby further reducing a time required to reach the personnel 112.

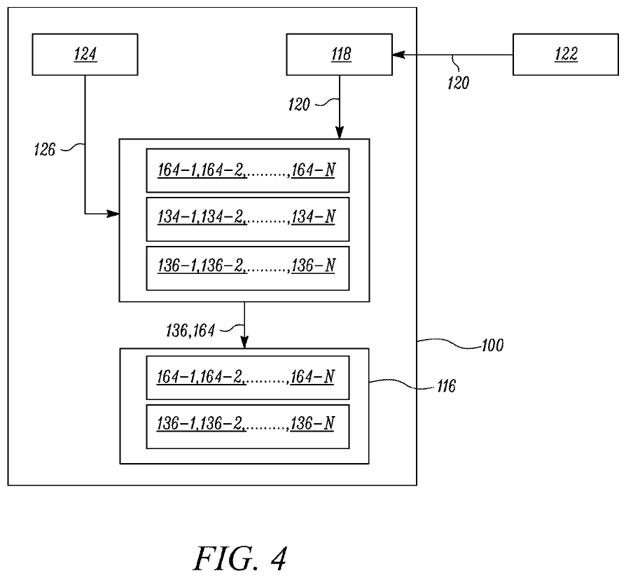

FIG. 4 is a block diagram illustrating the PRD 100, according to another embodiment of the present disclosure. In the illustrated embodiment of FIG. 4, the at least one obstacle-free path 134 determined by the processor 130 of the PRD 100 includes a plurality of obstacle-free paths 134-1, 134-2, . . . , 134-N (collectively, obstacle-free paths 134). For example, the processor 130 determines the plurality of obstacle-free paths 134 through the plurality of openings 104-1, 104-2 (shown in FIG. 1). Further, in some examples, the at least one set of guiding directions 136 includes a plurality of sets of guiding directions 136-1, 136-2, . . . , 136-N (collectively, sets of guiding directions 136) corresponding to the plurality of obstacle-free paths 134. In some examples, the processor 130 is further configured to display, via the display unit 116, the plurality of sets of guiding directions 136 corresponding to the plurality of obstacle-free paths 134.

In some examples, the processor 130 is further configured to determine a plurality of distances 164-1, 164-2, . . . , 164-N (collectively, distances 164) between the PDD 122 and the wireless receiver 118 corresponding to the plurality of obstacle-free paths 134. In some examples, the processor 130 is further configured to display, via the display unit 116, the plurality of distances 164 corresponding to the plurality of obstacle-free paths 134. Thus, the processor 130 displays the various routes and the corresponding distances from the PDD 122 to the wireless receiver 118.

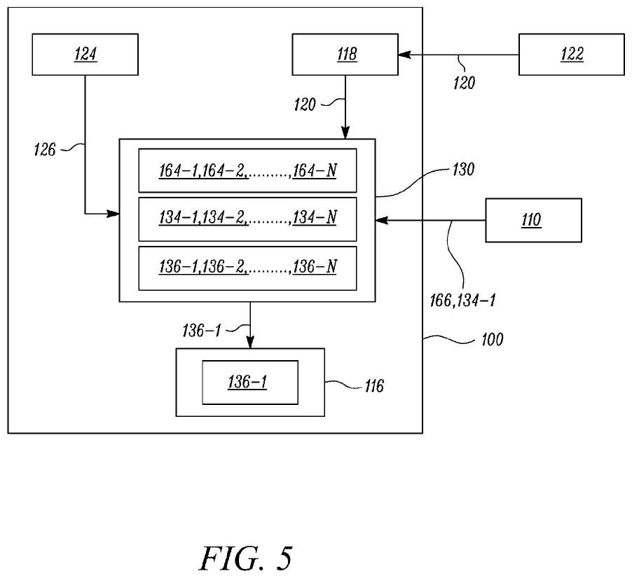

FIG. 5 is a schematic block diagram illustrating the PRD 100, according to another embodiment of the present disclosure. In some examples, the processor 130 is further configured to select one of the plurality of obstacle-free paths 134-1, 134-2, . . . , 134-N based on a user input 166. In some examples, the user 110 may select one of the plurality of obstacle-free paths 134-1, 134-2, . . . , 134-N displayed on the display unit 116 based on, e.g., a distance between the PDD 122 and the wireless receiver 118, ease of reaching to the personnel 112, the one or more path obstacles 132 (shown in FIG. 1), etc.

In some examples, the processor 130 is further configured to display, via the display unit 116, the set of guiding directions 136 corresponding to the selected one of the plurality of obstacle-free paths 134 while removing other of the plurality of sets of guiding directions 136 from the display unit 116. In the illustrated embodiment of FIG. 5, the user 110 chooses the obstacle-free path 134-1 and the processor 130 is further configured to display the set of guiding directions 136-1 on the display unit 116 while removing the other of the plurality of sets of guiding directions 136-2, . . . , 136-N from the display unit 116. In some examples, the user 110 may provide the user input 166 through, e.g., gestures, manipulating a joystick, pressing a button, etc.

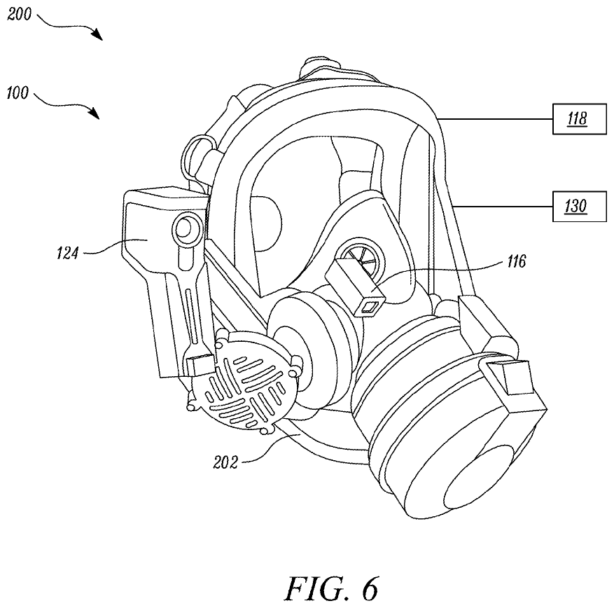

FIG. 6 is a schematic perspective view of an article of personal protective equipment (PPE) 200. Referring now to FIGS. 1-2 and 6, in some examples, the user 110 may utilize the article of PPE 200 before entering the hallway 102. In some examples, the article of PPE 200 includes a self-contained breathing apparatus (SCBA) or a powered air purifying respirator (PAPR).

Examples of article of PPE 200 may include, but are not limited to, respiratory protection equipment (including disposable respirators, reusable respirators, and supplied air respirators), facemasks, oxygen tanks, air bottles, protective eyewear, such as visors, goggles, filters or shields (any of which may include augmented reality functionality), protective headwear, such as hard hats, hoods or helmets, mining caps, hearing protection (including ear plugs and ear muffs), protective shoes, protective gloves, other protective clothing, such as coveralls, aprons, coat, vest, suits, boots and/or gloves, protective articles, such as sensors, safety tools, detectors, mining cap lamps, fall protection harnesses, exoskeletons, self-retracting lifelines, heating and cooling systems, gas detectors, and any other suitable gear configured to protect the user 110 from injury. The article of PPE 200 may include any other type of clothing or device/equipment that may be worn by the user 110 to protect against fire, extreme temperatures, reduced oxygen levels, explosions, reduced atmospheric pressure, radioactive and/or biologically harmful materials.

In some examples, the article of PPE 200 includes the PRD 100. In some examples, the PRD 100 is disposed on the article of PPE 200. In the illustrated embodiment of FIG. 6, the article of PPE 200 includes a face mask 202. Specifically, the face mask 202 includes the PRD 100. In some examples, the article of PPE 200 further includes the display unit 116 disposed on the face mask 202. The PRD 100 further includes the wireless receiver 118 configured to receive the distress signal 120 from the PDD 122 associated with the personnel 112. The PRD 100 further includes the at least one sensor 124 configured to generate the at least one obstacle signal 126 indicative of the one or more obstacles 106 in the ambient environment 128 around the PRD 100.

The PRD 100 further includes the processor 130 communicably coupled to each of the display unit 116, the wireless receiver 118, and the at least one sensor 124. The processor 130 is configured to determine the at least one set of guiding directions 136 and subsequently output the at least one set of guiding directions 136 through the display unit 116 mounted on the face mask 202. As the display unit 116 is mounted on the face mask 302, the user 110 may be able to easily access the at least one set of guiding directions 136 without significantly deviating attention from the intended tasks.

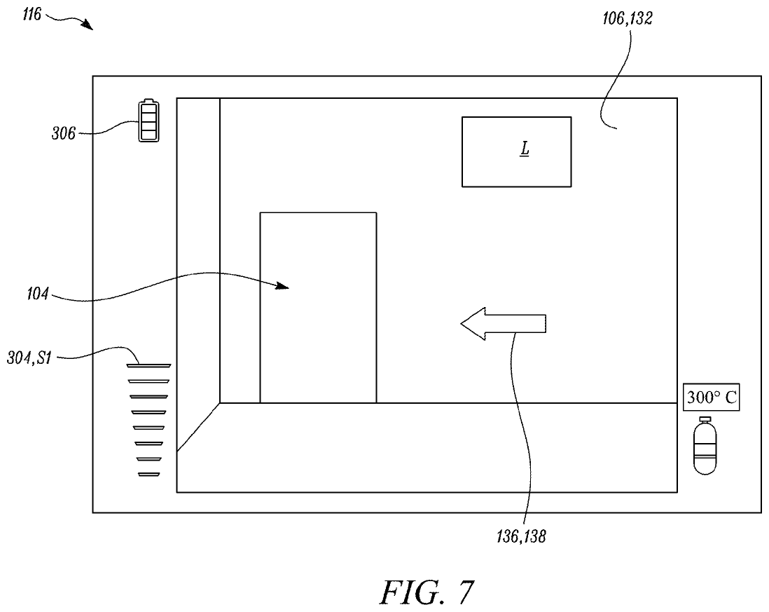

FIG. 7 is a schematic view of the display unit 116. Referring now to FIGS. 1-2 and 7, in some examples, the processor 130 is configured to display the signal strength S1 of the distress signal 120 on the display unit 116. In the illustrated embodiment of FIG. 7, the signal strength S1 is displayed via strength bars 304. In some examples, the strength bars 304 may be color coded in a range of different colors indicative of the strength of the distress signal 120. For example, the strength bars 304 may be highlighted with green (lowest strength), followed by yellow (intermediate strength), and then red (highest strength).

In some examples, the processor 130 is further configured to display the one or more obstacles 106 based on the at least one obstacle signal 126 received from the at least one sensor 124. Further, the processor 130 is further configured to display the one or more openings 104 through the one or more path obstacles 132. In some examples, the display unit 116 further outputs other information such as a status 306 of batteries used for powering the PRD 100, an ambient temperature, cylinder air pressure (e.g., of SCBA), etc.

The processor 130 is further configured to display the at least one set of guiding directions 136 for guiding the user 110 along the at least one obstacle-free path 134. The at least one set of guiding directions 136 includes the at least one guiding direction 138, such as an arrow, for directing the user 110 who is following the at least one obstacle-free path 134 to reach the personnel 112. In some examples, the processor 130 is further configured to display the remaining distance L between the PDD 122 and the wireless receiver 118.

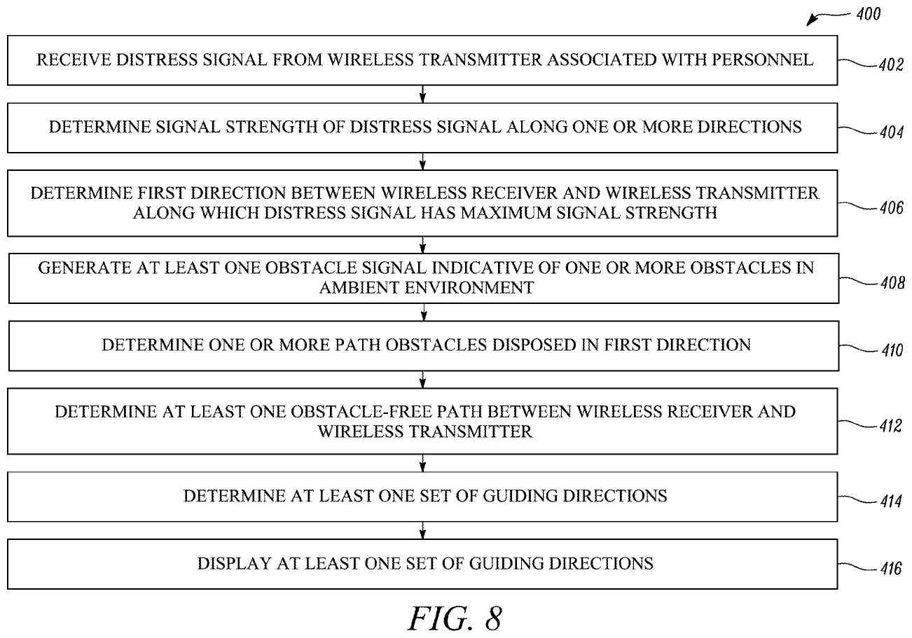

FIG. 8 is a flowchart illustrating a rescue method 400. The rescue method 400 will be described with reference to the PRD 100 of FIGS. 1-6. Referring now to FIGS. 1-6 and 8, at step 402, the rescue method 400 includes receiving, via the wireless receiver 118, the distress signal 120 from the PDD 122 associated with the personnel 112. At step 404, the rescue method 400 further incudes determining, via the processor 130 communicably coupled to the wireless receiver 118, the signal strength S1 of the distress signal 120 along one or more directions.

At step 406, the rescue method 400 further includes determining, via the processor 130, the first direction D between the wireless receiver 118 and the PDD 122 along which the distress signal 120 has the maximum signal strength S2 based on the signal strength S1 of the distress signal 120. The first direction D corresponds to the minimum distance T between the wireless receiver 118 and the PDD 122.

At step 408, the rescue method 400 further includes generating, via the at least one sensor 124 communicably coupled to the processor 130, the at least one obstacle signal 126 indicative of the one or more obstacles 106 in the ambient environment 128. In some examples, the at least one sensor 124 includes the plurality of sensors 124. In some examples, the at least one sensor 124 includes at least one of the lidar unit 140, the sonar unit 142, the infrared sensor 144, and the visible light sensor 146.

In some examples, generating the at least one obstacle signal 126 further includes generating, via the plurality of sensors 124 (i.e., the lidar unit 140, the sonar unit 142, the infrared sensor 144, and the visible light sensor 146) the corresponding plurality of obstacle signals 126 indicative of the one or more obstacles 106 in the ambient environment 128. In some examples, the plurality of obstacle signals 126 include at least one of the infrared signal 148 and the visible light signal 150. In some examples, the plurality of obstacle signals 126 further include at least one of the lidar signal 152 and the sonar signal 154. In some examples, generating the at least one obstacle signal 126 further includes combining, via the processor 130, the plurality of obstacle signals 126.

In some examples, the rescue method 400 further includes displaying, via the display unit 116, the signal strength S1 of the distress signal 120 and the one or more path obstacles 132. In some examples, the rescue method 400 further includes determining, via the processor 130, the one or more openings 104 through the one or more path obstacles 132, and displaying, via the display unit 116, the one or more openings 104.

At step 410, the rescue method 400 further includes determining, via the processor 130, the one or more path obstacles 132 disposed in the first direction D between the wireless receiver 118 and the PDD 122. The rescue method 400 further includes determining, via the processor 130, the parameter 156 associated with the one or more path obstacles 132, and displaying, via the display unit 116, the parameter 156. In some examples, the parameter 156 is indicative of the construction of the one or more path obstacles 132.

At step 412, the rescue method 400 further includes determining, via the processor 130, the at least one obstacle-free path 134 between the wireless receiver 118 and the PDD 122 based on the one or more path obstacles 132 and the first direction D. The at least one obstacle-free path 134 is unobstructed by the one or more path obstacles 132. In some examples, the at least one obstacle-free path 134 is determined without any predetermined map data.

At step 414, the rescue method 400 further includes determining, via the processor 130, the at least one set of guiding directions 136 for guiding the user 110 to the PDD 122 along the at least one obstacle-free path 134. The at least one set of guiding directions 136 includes the at least one guiding direction 138. At step 416, the rescue method 400 further includes displaying, via the display unit 116 communicably coupled to the processor 130, the at least one set of guiding directions 136.

In some examples, the rescue method 400 further includes storing the at least one set of guiding directions 136 in the memory 160 communicably coupled to the processor 130. In some examples, the rescue method 400 further includes outputting, via the audio device 162 communicably coupled to the processor 130, the at least one set of guiding directions 136. In some examples, the rescue method 400 further includes dynamically updating, via the processor 130, the at least one set of guiding directions 136 based on the position P of the user 110 along the at least one obstacle-free path 134. In some examples, the rescue method 400 further includes determining, via the processor 130, the remaining distance L between the PDD 122 and the wireless receiver 118 along the at least one obstacle-free path 134, and displaying, via the display unit 116, the remaining distance L.

In some examples, the at least one obstacle-free path 134 includes the plurality of obstacle-free paths 134-1, 134-2, . . . , 134-N. In some examples, the at least one set of guiding directions 136 includes the plurality of sets of guiding directions 136-1, 136-2, . . . , 136-N corresponding to the plurality of obstacle-free paths 134-1, 134-2, . . . , 134-N. In some examples, the rescue method 400 further includes determining, via the processor 130, the plurality of distances 164-1, 164-2, . . . , 164-N between the PDD 122 and the wireless receiver 118 corresponding to the plurality of obstacle-free paths 134-1, 134-2, . . . , 134-N. In some examples, the rescue method 400 further includes displaying, via the display unit 116, the plurality of sets of guiding directions 136-1, 136-2, . . . , 136-N corresponding to the plurality of obstacle-free paths 134-1, 134-2, . . . , 134-N. The rescue method 400 further includes displaying, via the display unit 116, the plurality of distances 164-1, 164-2, . . . , 164-N corresponding to the plurality of obstacle-free paths 134-1, 134-2, . . . , 134-N.

In some examples, the rescue method 400 further includes selecting, via the processor 130, one of the plurality of obstacle-free paths 134-1, 134-2, . . . , 134-N based on the user input 166. In some examples, the rescue method 400 further includes displaying, via the display unit 116, the set of guiding directions 136-1, 136-2, . . . , 136-N corresponding to the selected one of the plurality of obstacle-free paths 134-1, 134-2, . . . , 134-N while removing other of the plurality of sets of guiding directions 136-1, 136-2, . . . , 136-N from the display unit 116.

The PRD 100 of the present disclosure may receive the distress signal 120 from the PDD 122 associated with the personnel 112 to help locate the personnel 112 inside the hallway 102. Further, the processor 130 may determine the first direction D between the wireless receiver 118 and the PDD 122 along which the distress signal 120 has the maximum signal strength S2. Subsequently, the processor 130 may determine presence of the one or more path obstacles 132 disposed in the first direction D between the wireless receiver 118 and the PDD 122 (i.e., along the straight path to the PDD 122) based on the at least one obstacle signal 126 received from the at least one sensor 124. Thus, the PRD 100 of the present disclosure may be able to detect the one or more path obstacles 132 along the first direction D. Further, the processor 130 may determine the at least one obstacle-free path 134 based on the one or more path obstacles 132 and the first direction D, thereby circumventing the one or more path obstacles 132 and avoiding a path that may be blocked or impassable.

Thus, the PRD 100 of the present disclosure may assist in tracking (or locating) the personnel 112 by considering the one or more path obstacles 132 and determining the best path to reach the personnel 112. Further, the PRD 100 may save time in rescuing the personnel 112 by avoiding disorientation. The PRD 100 may also provide the at least one set of guiding directions 136 through the display unit 116, thereby guiding the user 110 along the at least one obstacle-free path 134. In some examples, at least one obstacle-free path 134 may include the plurality of obstacle-free paths 134-1, 134-2, . . . , 134-N. The PRD 100 may allow the user 110 to choose a suitable obstacle-free path 134 based on, e.g., a length of the obstacle-free path 134, ease of reaching the personnel 112, time required to reach the personnel 112, etc. Further, the at least one set of guiding directions 136 may include the at least one guiding direction 138 that may be dynamically updated along the obstacle-free path 134 to the PDD 122.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below, or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example.

Various examples have been described. These and other examples are within the scope of the following claims.

1. A portable rescue device (PRD) carried by a user, the PRD comprising:
a display unit;
a wireless receiver configured to receive a distress signal from a portable distress device (PDD) associated with a personnel, wherein the PDD is configured to utilize 2.4 GHz radio frequency (RF) protocols, long range (LoRa), ultra-wideband (UWB), a short-range wireless communication protocol in accordance with the IEEE 802.15.1 standard, angle of arrival (AoA), or a wireless local area network (WLAN) in accordance with IEEE 802.11 protocols, to transmit the distress signal;
at least one sensor configured to generate at least one obstacle signal indicative of one or more obstacles in an ambient environment around the PRD; and
a processor communicably coupled to each of the display unit, the wireless receiver, and the at least one sensor, wherein the processor is configured to:
determine a signal strength of the distress signal along one or more directions;
determine, based on the signal strength of the distress signal, a first direction between the wireless receiver and the PDD along which the distress signal has a maximum signal strength, wherein the first direction corresponds to a minimum distance between the wireless receiver and the PDD, wherein the signal strength is determined from the group consisting of received signal code power (RSCP), reference signal received power (RSRP), reference signal received quality (RSRQ), received signal strength indicator (RSSI), signal to noise ratio (SNR), and signal to interference plus noise ratio (SINR);
determine one or more path obstacles disposed in the first direction between the wireless receiver and the PDD based on the at least one obstacle signal received from the at least one sensor;
determine at least one obstacle-free path between the wireless receiver and the PDD based on the one or more path obstacles and the first direction, wherein the at least one obstacle-free path is unobstructed by the one or more path obstacles;
determine at least one set of guiding directions for guiding the user to the PDD along the at least one obstacle-free path, wherein the at least one set of guiding directions comprises at least one guiding direction; and
display, via the display unit, the at least one set of guiding directions.

2. The PRD of claim 1, wherein the at least one sensor comprises at least one of a lidar unit, a sonar unit, an infrared sensor, and a visible light sensor.

3. The PRD of claim 1, wherein the at least one sensor comprises a plurality of sensors configured to generate a corresponding plurality of obstacle signals indicative of the one or more obstacles in the ambient environment, and wherein the processor is further configured to fuse the plurality of obstacle signals in order to determine the one or more path obstacles.

4. The PRD of claim 3, wherein the plurality of obstacle signals comprise:
at least one of an infrared signal and a visible light signal; and
at least one of a lidar signal and a sonar signal.

5. The PRD of claim 1, wherein the processor is further configured to display, via the display unit, the signal strength of the distress signal and the one or more path obstacles.

6. The PRD of claim 1, wherein the processor is further configured to:
determine a parameter associated with the one or more path obstacles based on the at least one obstacle signal, wherein the parameter is indicative of a construction of the one or more path obstacles; and
display, via the display unit, the parameter.

7. The PRD of claim 1, wherein the processor is further configured to:
determine one or more openings through the one or more path obstacles based on the at least one obstacle signal; and
display, via the display unit, the one or more openings.

8. The PRD of claim 1, wherein the processor is configured to determine the one or more path obstacles further based on object detection.

9. The PRD of claim 1, further comprising a memory communicably coupled to the processor, wherein the memory is configured to store the at least one set of guiding directions.

10. The PRD of claim 1, further comprising an audio device communicably coupled to the processor, wherein the processor is further configured to output, via the audio device, the at least one set of guiding directions.

11. The PRD of claim 1, wherein the processor is further configured to dynamically update the at least one set of guiding directions based on a position of the user along the at least one obstacle-free path.

12. The PRD of claim 1, wherein the processor is further configured to:
determine a remaining distance between the PDD and the wireless receiver along the at least one obstacle-free path; and
display, via the display unit, the remaining distance.

13. The PRD of claim 1, wherein the at least one obstacle-free path comprises a plurality of obstacle-free paths, wherein the at least one set of guiding directions comprises a plurality of sets of guiding directions corresponding to the plurality of obstacle-free paths, and wherein the processor is further configured to:
determine a plurality of distances between the PDD and the wireless receiver corresponding to the plurality of obstacle-free paths;
display, via the display unit, the plurality of sets of guiding directions corresponding to the plurality of obstacle-free paths; and
display, via the display unit, the plurality of distances corresponding to the plurality of obstacle-free paths.

14. The PRD of claim 13, wherein the processor is further configured to:
select one of the plurality of obstacle-free paths based on a user input; and
display, via the display unit, the set of guiding directions corresponding to the selected one of the plurality of obstacle-free paths while removing other of the plurality of sets of guiding directions from the display unit.

15. The PRD of claim 1, wherein the processor is further configured to determine the at least one obstacle-free path without any predetermined map data.

16. An article of personal protective equipment (PPE) comprising the PRD of claim 1.

17. The article of PPE of claim 16, further comprising a face mask, wherein the display unit is disposed on the face mask.

18. The article of PPE of claim 16, further comprising a self-contained breathing apparatus (SCBA) or a powered air purifying respirator (PAPR).

19. A rescue method comprising:
receiving, via a wireless receiver, a distress signal from a portable distress device (PDD) associated with a personnel, wherein the PDD is configured to utilize 2.4 GHz radio frequency (RF) protocols, long range (LoRa), ultra-wideband (UWB), a short-range wireless communication protocol in accordance with the IEEE 802.15.1 standard, angle of arrival (AoA), or a wireless local area network (WLAN) in accordance with IEEE 802.11 protocols, to transmit the distress signal;
determining, via a processor communicably coupled to the wireless receiver, a signal strength of the distress signal along one or more directions;
determining, via the processor, a first direction between the wireless receiver and the PDD along which the distress signal has a maximum signal strength based on the signal strength of the distress signal, wherein the first direction corresponds to a minimum distance between the wireless receiver and the PDD, wherein the signal strength is determined from the group consisting of received signal code power (RSCP), reference signal received power (RSRP), reference signal received quality (RSRQ), received signal strength indicator (RSSI), signal to noise ratio (SNR), and signal to interference plus noise ratio (SINR);
generating, via at least one sensor communicably coupled to the processor, at least one obstacle signal indicative of one or more obstacles in an ambient environment;
determining, via the processor, one or more path obstacles disposed in the first direction between the wireless receiver and the PDD;
determining, via the processor, at least one obstacle-free path between the wireless receiver and the PDD based on the one or more path obstacles and the first direction, wherein the at least one obstacle-free path is unobstructed by the one or more path obstacles;
determining, via the processor, at least one set of guiding directions for guiding a user to the PDD along the at least one obstacle-free path, wherein the at least one set of guiding directions comprises at least one guiding direction; and
displaying, via a display unit communicably coupled to the processor, the at least one set of guiding directions.

20. The rescue method of claim 19, wherein the at least one sensor comprises at least one of a lidar unit, a sonar unit, an infrared sensor, and a visible light sensor.
